(19) United States
(12) Patent Application Publication
(10) Pub. No.: US 2007/0122609 A1
(43) Pub. Date: May 31, 2007

(54) Porous coatings on adsorbent materials

(76) Inventors: Laurence H. Hiltzik, Charleston, SC (US); Edward Donald Tolles, Charleston, SC (US); G. Frederick Hutter, Charleston, SC (US); David R.B. Walker, Lansdale, PA (US)

Correspondence Address: MEADWESTVACO CORPORATION, Division and Technical Center - Law Dept., PO BOX 118005, CHARLESTON, SC, 29423-8005, US

(21) Appl. No.: 11/698,006

(22) Filed: Jan. 25, 2007

Related U.S. Application Data
(63) Continuation-in-part of application No. 10/287,492, filed on Nov. 5, 2002, now Pat. No. 7,179,382.
Application No. 10/287,492 is a continuation-in-part of application No. 09/448,034, filed on Nov. 23, 1999, now abandoned.

(51) Int. Cl. B32B 27/30; B32B 27/32; B32B 3/26; B32B 27/12; B32B 9/04

(52) U.S. Cl. 428/304.4; 428/523; 428/522; 428/447; 442/121

(57) ABSTRACT

An adsorbent material, and method for making same, is disclosed wherein an application is made on the adsorbent material of a polymer coating with surface porosity. The product adsorbent material retains it adsorptive properties, while the coating provides advantages such as reduced dusting. For particulate or pellet forms of adsorbents, a reduction in attrited dust is useful for improved performance in emission control systems. The coating may also be used to color the product.

This application is a Continuation-in-Part application of commonly assigned, co-pending U.S. patent application Ser. No. 10/287,492 titled “Coated Activated Carbon for Automotive Emission Control,” filed on Nov. 5, 2002, which was a Continuation-in-Part application of Ser. No. 09/448,034 titled “Coated Activated Carbon,” filed on Nov. 23, 1999, and now abandoned. This application is also related to commonly assigned, co-pending application Ser. No. 10/985,410 titled “Colored Activated Carbon and Method of Preparation,” filed on Nov. 10, 2004, which was also a Continuation-in-Part application of Ser. No. 10/287,492. This application is also related to commonly assigned, co-pending application Ser. No. 10/929,845, titled “Coated Activated Carbon for Contamination Removal from a Fluid, filed Aug. 30, 2004, which was Continuation-in-Part of Ser. No. 10/287,493, now abandoned, which in turn was also a Continuation-in-Part of Ser. No. 09/448,034.

### BACKGROUND OF THE INVENTION

1. Field of the Invention

This invention relates to adsorbent materials having porous coatings that provide certain advantages with little or no detriment to dynamic adsorption performance. As an example, such adsorbent materials may include activated carbon pellets and activated granules for automotive emission control canisters where the porous coatings provide improved dusting characteristics or the ability to color the product. As another example, this invention relates to porous coatings on adsorbents susceptible to dust attrition due to abrasion where dusting can result in loss of product and often cause other problems related to its use in automotive emission control canisters. As another example, such adsorbent materials may include activated carbons in sheet form, carbon in or on paper substrates, or carbon in monolith or honeycomb forms, where the porous coatings provide desired properties, such as improved dusting characteristics or coloring. As yet another example, such adsorbents may include materials such as porous polymers and porous metal oxides, including aluminas, silicas, alumina-silicates, and zeolites where the porous coatings provide improved dusting characteristics or the ability to color the product. In each case the porous coatings do not detract from the dynamic adsorption performance of the adsorbent material.

2. Description of Related Art (Including Information Disclosed Under 37 CFR 1.97 and 37 CFR 1.98)

The invention as disclosed herein is useful with any form of adsorbent. Active carbon is used herein as one example of an adsorbent. Active carbon long has been used for removal of impurities and recovery of useful substances from liquids and gases because of its high adsorptive capacity. Generally, “activation” refers to any of the various processes by which the pore structure is enhanced. Typical commercial activated carbon products exhibit a surface area (as measured by nitrogen adsorption as used in the B.E.T. model) of at least 300 m²/g. For the purposes of this disclosure, the terms “active carbon” and “activated carbon” are used interchangeably. Typical activation processes involve treatment of carbon sources) such as resin wastes, coal, coal coke, petroleum coke, lignites, polymeric materials, and lignocellulosic materials including pulp and paper, residues from pulp production, wood (like wood chips, sawdust, and wood flour), nut shell (like almond shell and coconut shell), kernel, and fruit pits (like olive and cherry stones) either thermally (with an oxidizing gas) or chemically (usually with phosphoric acid or metal salts, such as zinc chloride).

Chemical activation of wood-based carbon with phosphoric acid (H3PO4) is disclosed in U.S. Pat. No. Re. 31,093 to improve the carbon's decolorizing and gas adsorbing abilities. Also, U.S. Pat. No. 5,162,286 teaches phosphoric acid activation of wood-based material which is particularly dense and which contains a relatively high (30%) lignin content, such as nut shell, fruit stone, and kernel. Phosphoric acid activation of lignocellulose material also is taught in U.S. Pat. No. 5,204,310 as a step in preparing carbons of high activity and high density.

Also, U.S. Pat. No. 4,769,359 teaches producing active carbon by treating coal cokes and chars, brown coals or lignites with a mixture of NaOH and KOH and heating to at least 500° C. in an inert atmosphere. U.S. Pat. No. 5,102,855 discloses making high surface area activated carbon by treating newspapers and cotton linters with phosphoric acid or ammonium phosphate. Coal-type pitch is used as a precursor to prepare active carbon by treating with NaOH and/or KOH in U.S. Pat. No. 5,143,889.

Once the activated carbon product is prepared, however, it may be subject to some degradation before and during its use. Abrading during materials handling and actual use of such activated carbon results in loss of material in the form of dust. Such “dusting” of the product is a function of its relative hardness and its shape, as well as how it is handled in the plant±in moving it into and out of plant inventory, in loading for transport and in off-loading by the receiver, and how it is handled by the receiver to place the product into use. In certain applications, such as employment in canisters in automobiles where the activated carbon is subject to constant vibration and may have to withstand collision, product degradation by dusting continues through the life of the product.

The hardness of an activated carbon material is primarily a function of the hardness of the precursor material, such as a typical coal-based activated carbon being harder than a typical wood-based activated carbon. The shape of granular activated carbon also is a function of the shape of the precursor material. The irregularity of shape of granular activated carbon, i.e., the availability of multiple sharp edges and corners, contributes to the dusting problem. Of course, relative hardness and shape of the activated carbon are both subject to modification. For example, U.S. Pat. Nos. 4,677,086, 5,324,703, and 5,538,932 teach methods for making pelleted products of high density from lignocellulosic precursors. Also, U.S. Pat. No. 5,039,651 teaches a method of producing shaped activated carbon from cellulosic and starch precursors in the form of “tablets, plates, pellets, briquettes, or the like.” Further, U.S. Pat. No. 4,221,695 discloses making an “Adsorbent for Artificial Organs” in the form of beads by mixing and dissolving petroleum pitch with an aromatic compound and a polymer or copolymer of a chain hydrocarbon, dispersing the resultant mixture in water giving rise to beads, and subjecting these beads to a series of treatments of removing of the aromatic hydrocarbon, infusibilizing, carbonizing, and finally activating.

Despite these and other methods of affecting activated carbon hardness and shape, however, product dusting continues to be a problem in certain applications. For example, in U.S. Pat. No. 4,221,695, noted above, the patentees describe conventional beads of a petroleum pitch-based activated carbon intended for use as the adsorbent in artificial organs through which the blood is directly infused that are not perfectly free from carbon dust. They observe that some dust steals its way into the materials in the course of the preparation of the activated carbon, and some dust forms when molded beads are subjected to washing and other treatments. The patentees note that the application of a film-forming substance to the surface of the adsorbent “is nothing to be desired,” because the applied substance acts to reduce the adsorption velocity of the matters to be adsorbed on the adsorbent and limit the molecular size of such matters being adsorbed.

Subsequently, in U.S. Pat. No. 4,476,169, the patentees describe a multilayer glass window wherein vapor between the glass sheets is adsorbed by a combination of a granular zeolite with granular activated carbon having its surface coated with 1-20 wt % synthetic resin latex. The coating of the activated carbon is described as greatly inhibiting the occurrence of dust without substantially reducing the absorptive power of activated carbon for an organic solvent. However this patent does not address dynamic working capacity.

Automotive canisters for controlling fuel vapor emissions use activated carbon in either granular or pelletized forms. Activated carbons, regardless of their form and size, contain some portion of smaller particles, or dust, which can be problematic for valves and filters associated with the canister. This dust can present a nuisance at canister filling operations that dispense and convey bulk quantities of activated carbon. Reduction of dust can reduce the likelihood of valves and filters on canisters becoming partially or fully blocked and relieve the nuisance issues at canister filling locations. Dust issues can arise from either initial dust present as a result of sizing and screening inefficiencies or from dust generated by the action of pellets and granules against one another, which can be quantified as a dust attrition rate.

In addition to dust suppression, the coatings can provide a means of colorizing activated carbon so that it has an appearance besides the customary black. Color can serve as a means of identifying different grades and/or manufacturing dates for activated carbon. Different color coatings can provide an effective means of differentiating between different grades, such as low bleed pellets and high capacity pellets that are used in a dual-fill canister that has high capacity and low bleed emissions. Color can also be used as a means of identifying the year the activated carbon was manufactured. Another use of color coating is for quality assurance. For example an automotive manufacturer could demand red BAX 1500 as a means of assuring that a certain manufacturer's product is used.

When a colored adsorbent material is desired, this may be achieved by adding an insoluble colorant to the coating. The insoluble colorant may be a pigment. It may be an organic or inorganic compound or compounds. The insoluble colorant may be a powder, dispersion, chromophore grafted to an insoluble solid additive, colorant immobilized in the coating, or chromophore grafted to the polymer. The insoluble colorant may be an indicator compound, such as a compound that may gain color, change color, or lose color.

Patent applications previously filed by the applicant disclose polymer coating of activated carbon to impart dust-free properties, with the option of color, without detracting from adsorption capacity and without detracting from bed packing. Some properties, such as anti-dusting or coating slip properties, may relate more to particulate or pellet forms of the adsorbent, particularly to the use of carbon in packed beds and, in some instances, specific to particulate carbon for evaporative emission control canisters. It is now recognized that properties such as anti-dusting and color coding, in conjunction with a porous coating that does not degrade dynamic adsorption performance, may also be desired for other forms of adsorbents, such as adsorbents in sheet form, in or on paper substrates, or in monolith or honeycomb forms. Furthermore, certain porous polymer coatings may be useful for example to provide dust-free properties for honeycombs or papers, although these polymer coatings may be unattractive for adsorbents in particulate or pellet form due to deleterious effects on bed packing.

For alternative adsorbent structures, such as carbon in honeycomb or paper forms, rates of adsorption and desorption, lengths of mass transfer zones, and levels of bleed emissions are critical performance factors for uses including evaporative emission control systems, pressure swing adsorption beds, appliance odor control filters, cabin air filters, fuel tank vapor control systems, solvent vapor recovery systems, and solvent concentrator systems. These uses have adsorption rate needs that are in stark contrast with some other uses, such as the multipane window application of coated carbon in prior art U.S. Pat. No. 4,476,169, where equilibrium capacity is important, yet dynamic performance is inconsequential to the carbon's effectiveness. However, prior art did not teach a coating method suitable for adsorptive filters where rates of adsorption are critical. For example, the prior art polymers of styrene butadiene and acrylonitrile latex that were examples in prior art U.S. Pat. No. 4,476,169 are now shown to have unacceptable effects on dynamic performance.

### BRIEF DESCRIPTION OF THE DRAWINGS

FIG. 1 shows micrographs of coated carbons where the coatings have surface openings appearing as microfissures.

FIG. 2 shows micrographs of coated carbons where the coatings do not have recognizable surface openings.

FIG. 3 shows graphs of the effect of surface openings on canister working capacity for activated carbon.

FIG. 4 is a cross sectional schematic view of a canister holding an adsorbent.

FIG. 5 is a schematic of equipment used in a canister cycling test.

### SUMMARY OF THE INVENTION

It has been discovered that the dynamic working capacity of an adsorbent can be maintained with little or no change after application of a polymer coating, if the coating has a surface provided with porosity, for example in the form of microfissures. Thus the beneficial effects of a coating, such as coloring or reduced product attrition by dusting of adsorbents in granular, shaped, sheet, or monolith form can, in fact, be achieved without detriment to dynamic working capacity, by the application to the adsorbent of a thin, continuous polymer coating having surface porosity. The avoidance of attrited adsorbent dust leads to improved canister performance in emission control, and the ability to color an adsorbent provides functional (e.g., identification) or esthetic benefits. Meanwhile the dynamic working capacity of the adsorbent is not degraded by the porous polymer coating.

### DESCRIPTION OF THE PREFERRED EMBODIMENT(S)

Dusty automotive carbon pellets pose potential problems in materials handling and in canister applications. A method is disclosed based on applying a porous polymer coating on an adsorbent material while still retaining the effectiveness of the adsorbent, even under dynamic conditions.

The process for essentially eliminating dust attrition of an adsorbent material by coating the adsorbent material comprises the steps of a) applying an emulsion of the polymer onto exposed surfaces of the adsorbent material and b) drying the coated adsorbent material to produce a coated surface having openings, such as microfissures, crevices, cracks, holes, or craters.

The application of the polymer coating, especially for particulate or pellet forms of adsorbent, may be done by spraying. Other application methods may be used for applying the polymer coating. Other adsorbent forms may be used, such as sheets, monoliths, or honeycombs.

The process may optionally include an initial step of preheating the adsorbent material to above ambient temperature. The process may include multiple repetitions of steps (a) and (b). Also, the process of the claimed invention may comprise a further step of de-dusting the dried coated adsorbent material by removing any residual dust therefrom.

As those skilled in the art appreciate, various processing conditions are generally interdependent, such as processing time and processing temperature. These operating conditions as well may depend on the nature of the adsorbent material to be coated (shaped or granular, coal-based or lignocellulosic-based, etc.) and the coating material (relative volatility, viscosity, etc.). Thus, the temperature range for coating application and coating drying steps may range from just below ambient at about 50° F., up to about 280° F. (138° C.), and the processing time may take from about 1 minute to about 12 hours. For most combinations of shaped or granular active carbon material and coating material, a preferred operating temperature range for the coating and drying steps is from about 70° F. (21° C.) to about 250° F. (121° C.) for from about 5 minutes to about 6 hours.

A turbulent state of the adsorbent material, which may be useful when processing particulate or shaped forms can be induced by various known means. For example, the adsorbent material, in granular or shaped (usually pellet) form, may be placed in a rotary tumbler, in a mixing device, or on a fluidized bed. While it is desirable that the adsorbent material be in a kinetic, rather than static, state when the coating material is applied to assure relatively even coating on the surface area of the adsorbent material, it is not critical how the kinetic state is achieved. The adsorbent may be coated without requiring the materials to be in turbulent motion.

The product of the invention process may be described as a composition of matter comprising an adsorbent material exhibiting initial, pre-coating butane activity, butane working capacity, and dynamic working capacity values and having its surface coated with a continuous, porous film of a polymer, said polymer film being operable for coloring and/or essentially eliminating attrition of the adsorbent material resulting from dusting, and wherein the coated adsorbent material exhibits final, post-coating butane activity and butane working capacity values of 90-100% of the initial, pre-coating butane working capacity values, respectfully and dynamic working capacity values of 80% to 100% of the initial, pre-coating dynamic working capacity.

The coating materials useful in the claimed invention are those capable of forming a continuous film. In particular, polymers, copolymers, and polymer blends that are suitable coating materials include: polyolefins, such as polyethylene, polypropylene, polyisobutylene, polystyrene, polyisoprene, polychloroprene, poly-4-methyl-1-pentene, polybutadiene, and polybutene; polyacrylics, such as polyacrylates, polymethyl methacrylate, polybutylmethacrylate, polymethacrylates, and polyacrylic acid; halogen-substituted alkanes, such as polytetrafluoroethylene, trifluoroethylene, vinyl fluoride, fluorvinylidene, fluorobutylene, and fluoropropylene; and other polymers including polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate, phthalate, cellulose propionate morpholinobutyrate, hydroxypropylmethyl cellulose, ethylene vinyl acetate, acrylic copolymers, polysulfones, polyether sulfones, polyethers, polyethylene, glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, methacrylonitrile, polyacrylonitrile, polyvinyl pyridine, polyvinyl benzene, polyvinyl acetate, polyvinyl pyrrolidene, polyvinyl butyral, polyvinyl alcohol, polyvinyl chloride, polyvinyl formaldehyde, polyformaldehyde, polycarbonates, and polyvinylidene chloride.

The shaped or granular adsorbent material of the invention may include without limitation materials such as active carbon, porous polymers and porous metal oxides, including aluminas, silicas, alumina-silicates, and zeolites, and other adsorbents. When active carbon is used, the active carbon material of the invention described herein may be derived from any known active carbon precursors including coal, lignocellulosic materials, including pulp and paper, residues from pulp production, wood (like wood chips, sawdust, and wood flour), nut shell (like almond shell and coconut shell), kernel, and fruit pits (like olive and cherry stones), petroleum, bone, and blood.

Co-pending U.S. application Ser. No. 10/287,492 disclosed a method for treating adsorbent materials with coatings, and properties of materials that were treated, along with test methods for determining effective of the adsorbent including butane activity and butane working capacity (BWC) values determined according to the procedure disclosed in U.S. Pat. No. 5,204,310, whose teaching is incorporated by reference herein.

As a result of polymer coatings, treated adsorbent samples showed sharply reduced levels of initial dust and dust rate values. As measured by the “Standard Test Method for Dusting Attrition of Granular Carbon” (ASTM D5159-91).

U.S. application Ser. No. 10/287,492 disclosed that BWC, while useful, is not the sole measure of canister performance. Some coated activated carbons may have little or no loss of BWC so that they appear similar to uncoated activated carbon suitable for use in ORVR applications, when in fact mass transfer resistance imposed by the coating on the exterior of the activated carbon reduces the capacity under ORVR conditions. With polyethylene coatings below 3.5%, BWC and ORVR capacity was essentially unchanged but with a coating greater than about 3.5%, ORVR capacity dropped and would require a larger canister to have the same adsorptive capacity as pellets with less or no coating. Other polymers besides polyethylene might produce an adverse effect, particularly on ORVR capacity, at a coating content of 3% or more,

An indication of whether a coated activated carbon is useful for automotive canisters is the apparent density of the activated carbon after the coating is applied. Within the canister, good packing of the adsorbent is typically desired, as indicated by a relatively higher apparent density (or relatively lower void volume). Of the polymers tested, polyethylene and an acrylic copolymer caused the least packing disruption and gave the highest BWC values while also giving low initial dust and dust attrition rates. BWC losses correspond to decreased apparent densities of the coated pellets and of the activated carbon inside a canister.

U.S. application Ser. No. 10/287, 492 also disclosed that a variety of colored carbons can be prepared by choosing the proper combination of pigments for addition to the polymer emulsion and the emulsion application methods, in order to attain the desired color, plus obtain the desired benefits of the coating. A range of colors were obtained by coating particular activated carbons with different pigments while retaining more than 98% of the original BWC of the parent activated carbon.

Further testing, as described herein, revealed that the dynamic adsorption performance varied substantially for carbons coated with several different polymer coatings. Micron-sized openings in polymer coatings were identified as important for maintaining unhindered dynamic adsorption performance for dust-free coated carbons. These openings were observed in scanning electron micrographs as patterns of microfissures, crevices, or cracks on the coating surface. Some of the tested polymers naturally form these microfissures, crevices, or cracks when applied to carbon by a spray emulsion method. Other tested polymers do not appear to form the surface openings.

However, when polymer coatings were free of these observed openings, canister beds of the carbons exhibited premature breakthrough of the mass transfer zone and reductions in working capacity of up to 80% compared with the uncoated base carbons. There was also a propensity for excessively high “bleedthrough” emissions prior to breakthrough of the mass transfer zone. The degree of the effect on dynamic adsorption performance was surprising because all coated carbons typically showed equilibrium adsorption to be unhindered and BWC affected by 20% at most.

It should be noted that while the tests here used active carbon as the adsorbent material, it is expected that the results would also apply to other adsorbent materials, such as porous polymers and porous metal oxides, including aluminas, silicas, alumina-silicates, and zeolites, and other adsorbents.

Dynamic adsorption is a key desirable feature for the use of adsorbent forms including particulate, granular or pellet, sheet- or paper-form, and monoliths or honeycombs. Dust-free properties, and also the ability to color the product, may also be highly valued for all these forms.

The breakpoint between surface opening area of the coating and canister performance occurred at about 1 mm of microfissure (crevice, or crack)—length per mm2 of coated surface, equal to about 2 μm² microfissure (crevice, or crack)—open area per mm² of coated surface. The presence of surface openings as seen by microfissure features and the maintenance of dynamic performance in canister beds were demonstrated when 2 mm BAX 1100 pellets (activated carbon made by MeadWestvaco Corporation) were coated with 2 wt % of polyethylene, polypropylene, TFE, or acrylic copolymer (JONREZ® E-2062).

The coincidence of a lack of surface openings and poor cycling performance was demonstrated when BAX 1100 was coated with 2 wt % of styrene butadiene, polyethylene acrylic copolymer, acrylonitrile polymer, or styrene acrylic copolymer (JONREZ® E-2050).

Furthermore, the effect on dynamic performance was shown to be dependent on the presence of defects and not the polymer per se based on an experiment that compared twice coated carbon and a single coated carbon, both to a total loading of 2 wt % polyethylene. Therefore, it is proposed that those polymers that do not naturally form surface openings could be improved by incorporating such openings in the coatings by alternative means. Alternative means of incorporating or causing openings may include controlling (e.g., reducing) the elasticity or increasing the glass transition temperature (Tg) of the polymer so that openings form upon drying or heat treatment. Another potential method of causing coating openings is by adding solubilizing, volatilizing, or sublimation additives to the coating to create openings upon supplemental washing, drying, or heat treatment. Another potential method is by adding volatilizing or sublimation additives to the carbon or other adsorbent material prior to coating and then rapidly flashing these compounds out of the coated carbon or other adsorbent material to create openings after coating formation. Still other potential methods of causing coating openings include rapid drying of the polymer coating, adding solids that stay with the polymer coating and result in disruptions at the polymer-solid interface, and physical means such as laser ablation, tumbling, vibration, or other means to disrupt the coating.

Surface openings in a coating may be useful for many alternative uses of activated carbon or other adsorbents, such as for honeycombs, papers, and pleated filters that are oftentimes used in scrubbing devices. These devices are often used in fluid flow systems for reducing the evolution of vapors during adsorption (a.k.a. “bleedthrough”) and extending adsorption cycles by preventing breakthrough of the mass transfer zone. These uses include evaporative emission control systems, pressure swing adsorption beds, appliance odor control filters, cabin air filters, fuel tank vapor control systems, solvent vapor recovery systems, and solvent concentrator systems.

While activated carbon is used herein as an example adsorbent material, it should be understood that the porous coatings may be used for other types of adsorbents, including by example, such adsorbent materials as porous polymers and porous metal oxides, including aluminas, silicas, alumina-silicates, and zeolites.

### Experimental Results

Standard Property Tests. Table I lists descriptions of samples of 2 mm BAX 1100 carbon that were prepared and tested. Table II lists the BWC test and dust attrition property comparisons for the coated carbon samples, both in absolute terms, and in percent change relative to the uncoated base carbons. There were small reductions in weight activity compared with expected 2% dilution effects from the 2 wt % additions of the polymers. Volume activities were reduced the most by the coatings of styrene butadiene, acrylonitrile butadiene, and polypropylene—polymers with poor slip properties that may impair volumetric packing of particles.

TABLE I
Sample Descriptions

| Sample ID | Coating Type | Coating Emulsion |
|---|---|---|
| A.0 | Uncoated BAX 1100 | — |
| A.1 | 2 wt % polyethylene | ChemCor 325G |
| A.2 | 2 wt % acrylonitrile butadiene | Hycar ® 1572 latex |
| A.3 | 2 wt % carboxylated styrene butadiene | Dow CP-620 |
| B.0 | Uncoated BAX 1100 | — |
| B.1 | 2 wt % acrylic copolymer | JONREZ ® E-2062 (Tg = 89° C.) |
| B.2 | 2 wt % polypropylene | ChemCor 43N40 |
| B.3 | 2 wt % TFE | ChemCor Chemslip 55 |
| B.4 | 2 wt % polyethylene | ChemCor 325G |
| B.5 | 1 wt % + 1 wt % polyethylene (twice | ChemCor 325G |
| | coated) | |
| B.6 | 2 wt % styrene acrylic copolymer | JONREZ ® E-2050 (Tg = −3° C.) |
| B.7 | 2 wt % polyethylene acrylic copolymer | ChemCor WE4-25A |

All coated carbons demonstrated substantially lower levels of initial dust and dusting rates compared with the uncoated base carbons. Therefore, the results for weight basis activity and lowered dusting levels by the coatings are consistent with prior art (e.g., U.S. Pat. No. 4,476,169).

The bold lines in Table II delineate from the group those samples that have relatively larger losses in purgeability (shown as “butane ratio,” or the fraction of the volume activity that was recoverable by the set flow of air in the purge step of the test). The samples with the highest losses in purgeability (4-11%) had the highest net losses of BWC, 7-20% compared with the base carbons. These data show the negative impact of certain polymers (for example styrene butadiene and acrylonitrile latex) on carbon based on purge performance in the BWC test, a surrogate measure of working capacity potential for evaporative emission control filters.

TABLE II
Standard Test Properties

| | | | Butane | Butane | | | | |
|---|---|---|---|---|---|---|---|---|
| | | | Weight | Volume | | | Initial | Dust |
| Sample | | AD | Activity | Activity | Butane | BWC | Dust | Rate |
| ID | Coating Type | g/cc | g/100 g | g/dL | Ratio | g/dL | mg/dL | mg/min/dL |
| A.0 | Uncoated BAX 1100 | 0.361 | 8.4 | 13.9 | 0.848 | 11.8 | 11.6 | 0.73 |
| A.1 | 2 wt % polyethylene | 0.375 | 36.5 | 13.7 | 0.851 | 11.6 | 1.6 | 0.03 |
| A.2 | 2 wt % acrylonitrile | 0.334 | 36.9 | 12.3 | 0.763 | 9.4 | 0.7 | 0.02 |
| | butadiene | | | | | | | |
| A.3 | 2 wt % styrene | 0.361 | 37.1 | 13.4 | 0.757 | 10.2 | 0.6 | 0.01 |
| | butadiene | | | | | | | |
| B.0 | Uncoated BAX 1100 | 0.366 | 36.5 | 13.4 | 0.854 | 11.4 | 8.6 | 0.51 |
| B.1 | 2 wt % acrylic | 0.366 | 35.7 | 13.1 | 0.855 | 11.2 | 1.0 | 0.07 |
| | copolymer | | | | | | | |
| B.2 | 2 wt % polypropylene | 0.362 | 35.3 | 12.8 | 0.856 | 11.0 | 2.9 | 0.07 |
| B.3 | 2 wt % TFE | 0.365 | 35.5 | 12.9 | 0.859 | 11.1 | 1.5 | 0.08 |
| B.4 | 2 wt % polyethylene | 0.375 | 35.3 | 13.3 | 0.852 | 11.3 | 0.8 | 0.00 |
| B.5 | 1 wt % + 1 wt % | 0.377 | 35.3 | 13.3 | 0.837 | 11.1 | 1.6 | 0.03 |
| | polyethylene | | | | | | | |
| B.6 | 2 wt % styrene acrylic | 0.360 | 35.3 | 12.7 | 0.767 | 9.7 | 0.8 | 0.01 |
| | copolymer | | | | | | | |
| B.7 | 2 wt % PE acrylic | 0.375 | 34.4 | 12.9 | 0.821 | 10.6 | 0.5 | 0.02 |
| | copolymer | | | | | | | |

Standard Test Properties - Relative to Uncoated

| | | | Butane | Butane | | | | |
|---|---|---|---|---|---|---|---|---|
| Sample | | | Weight | Volume | Butane | | Initial | Dust |
| ID | Coating Type | AD | Activity | Activity | Ratio | BWC | Dust | Rate |
| A.1 | 2 wt % polyethylene | +4% | −5% | −1% | 0% | −1% | −86% | −96% |
| A.2 | 2 wt % acrylonitrile | −8% | −4% | −11% | −10% | −20% | −94% | −97% |
| | butadiene | | | | | | | |
| A.3 | 2 wt % styrene | 0% | −3% | −3% | −11% | −14% | −95% | −99% |
| | butadiene | | | | | | | |
| B.1 | 2 wt % acrylic | 0% | −2% | −2% | 0% | −2% | −88% | −87% |
| | copolymer | | | | | | | |
| B.2 | 2 wt % polypropylene | −1% | −3% | −4% | 0% | −4% | −67% | −85% |
| B.3 | 2 wt % TFE | 0% | −3% | −3% | +1% | −3% | −82% | −85% |
| B.4 | 2 wt % polyethylene | +3% | −3% | −1% | 0% | −1% | −91% | −99% |
| B.5 | 1 wt % + 1 wt % | +3% | −3% | 0% | −2% | −2% | −82% | −94% |
| | polyethylene | | | | | | | |
| B.6 | 2 wt % styrene acrylic | −2% | −3% | −50% | −10% | −15% | −91% | −99% |
| | copolymer | | | | | | | |
| B.7 | 2 wt % PE acrylic | +2% | −6% | −3% | −4% | −7% | −94% | −96% |
| | copolymer | | | | | | | |

BWC is related to the volume of small mesopores in the range of 18-50 Å size, as taught in U.S. Pat. No.5,204,310, whereas total butane adsorption is related to the total amount of pores <50 Å in size. Smaller size pores, <18 Å, are strongly adsorbing and contribute to equilibrium adsorption but are not readily purgeable under the conditions of the test. Butane Ratio is defined as the proportion of the total butane that is purgeable (BWC divided by volume-basis butane activity) and, by extension, is related to the proportion of total pores less than 50 Å in size that are 18-50 Å in size which adsorb vapors with only moderate strength. Note that the BWC value is not an equilibrium property since, despite being related to the pore volume and pore size distribution of the activated carbon, hindered transport of vapors from the interior of activated carbon particle has the potential to reduce the rate, and therefore the cumulative total, removal of butane into the purge stream. A treatment to the carbon, such as a coating, that hinders vapor or contaminant transport into or out of the carbon, has the potential to reduce butane ratio even though the internal porosity of the carbon is otherwise unaffected.

2-Liter Canister Tests. Although the reductions in BWC were as much as 20%, the effects of some of the coatings were much more dramatic when the carbons were tested in a canister bed configuration that was cycled through repeated steps of adsorption and purge, with performance determined by active measurements of vapor emissions.

Table III shows the canister working capacity under cycling conditions and the surface porosity property comparisons for the coated carbon samples, both in absolute terms, and as a percent change relative to the uncoated base carbons. (The bold lines that delineated effects on butane ratio in Table II are preserved in Table III.)

TABLE III
Canister Performance and Concentration of Surface Openings

| | | Canister | | | |
|---|---|---|---|---|---|
| | | Working | | | |
| | | Capacity | Bleed | Surface Openings | |
| Sample ID | Coating Type | g/L | ppm | mm/mm² | μm²/mm² |
| A.0 | Uncoated BAX 1100 | 42.4 | 500 | — | — |
| A.1 | 2 wt % polyethylene | 42.5 | 500 | 29 | 44 |
| A.2 | 2 wt % acrylonitrile | 8.1 | 10000 | 0 | 0 |
| | butadiene | | | | |
| A.3 | 2 wt % styrene butadiene | 13.2 | 3200 | 0 | 0 |
| B.0 | Uncoated BAX 1100 | 41.7 | 600 | — | — |
| B.1 | 2 wt % acrylic | 41.1 | 500 | 49 | 74 |
| | copolymer | | | | |
| B.2 | 2 wt % polypropylene | 39.0 | 400 | 25 | 37 |
| B.3 | 2 wt % TFE | 41.2 | 500 | 19 | 28 |
| B.4 | 2 wt % polyethylene | 40.1 | 600 | 4 | 6 |
| B.5 | 1 wt % + 1 wt % | 33.6 | 400 | 1.4 | 2.1 |
| | polyethylene | | | | |
| B.6 | 2 wt % styrene acrylic | 11.3 | 60000 | 0 | 0 |
| | copolymer | | | | |
| B.7 | 2 wt % PE acrylic | 21.7 | 700 | 0 | 0 |
| | copolymer | | | | |

Properties Relative to Uncoated

| | | | | | |
|---|---|---|---|---|---|
| A.1 | 2 wt % polyethylene | 0% | 0% | — | — |
| A.2 | 2 wt % acrylonitrile | −81% | +1900% | — | — |
| | butadiene | | | | |
| A.3 | 2 wt % styrene butadiene | −69% | +540% | — | — |
| B.1 | 2 wt % acrylic | −1% | −17% | — | — |
| | copolymer | | | | |
| B.2 | 2 wt % polypropylene | −6% | −33% | — | — |
| B.3 | 2 wt % TFE | −1% | −17% | — | — |
| B.4 | 2 wt % polyethylene | −4% | 0% | — | — |
| B.5 | 1 wt % + 1 wt % | −19% | −33% | — | — |
| | polyethylene | | | | |
| B.6 | 2 wt % styrene acrylic | −73% | +9900% | — | — |
| | copolymer | | | | |
| B.7 | 2 wt % PE-acrylic | −48% | +17% | — | — |
| | copolymer | | | | |

The data show that coated carbons with losses in butane ratio of 4-11% had canister working capacity reductions of 48-81%. In addition, there was a tendency with some coatings to have high levels of emissions through the bed during adsorption and prior to breakthrough of the mass transfer zone, a phenomenon known as vapor “bleedthrough.” Bleedthrough emissions during adsorb cycles for some coated carbons were increased by as much as 100-fold over the levels measured for uncoated carbons.

For convenience, the canister working capacity will be considered a measurement of “dynamic working capacity,” that is, how well the adsorbent performs under cycling conditions.

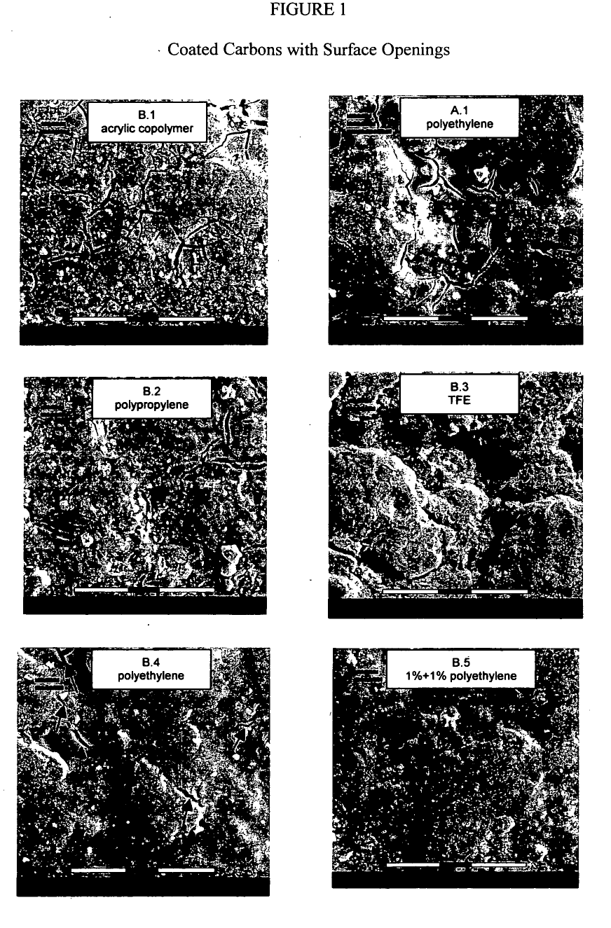

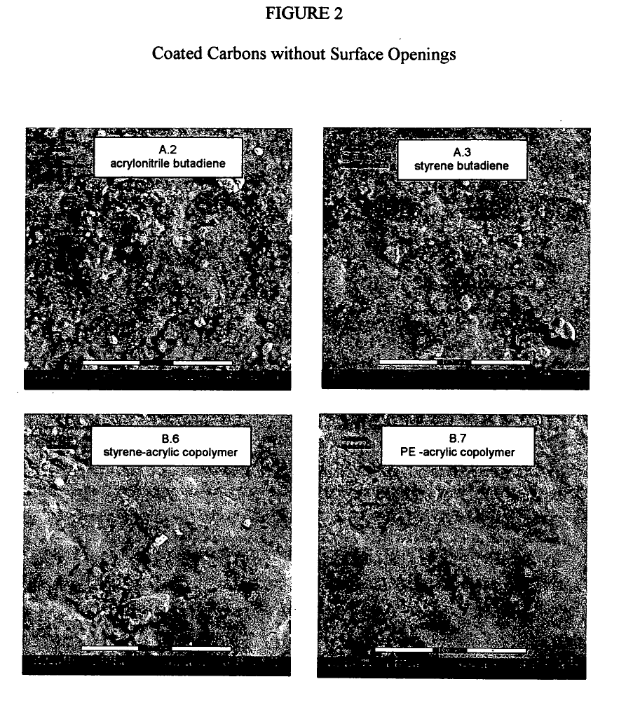

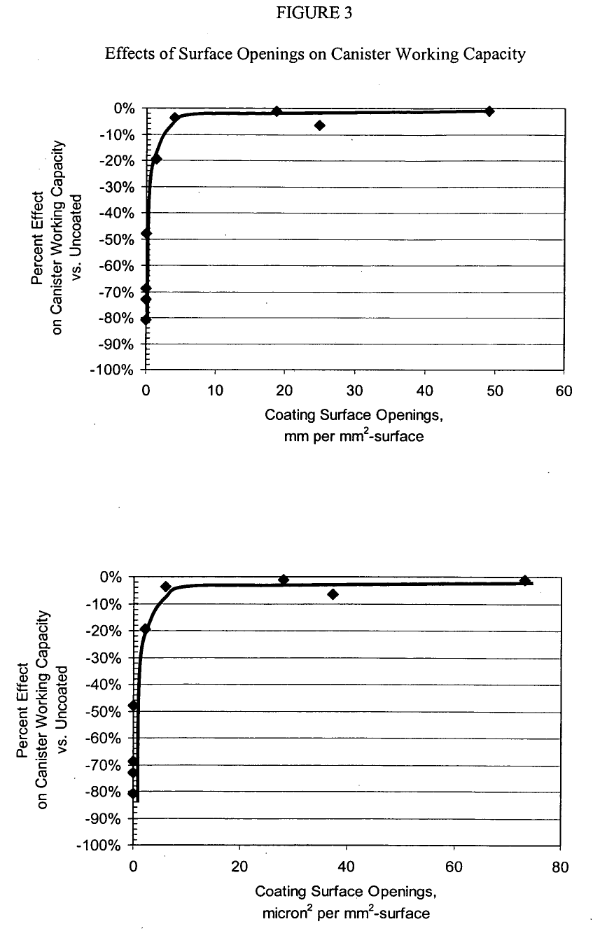

Surface Morphology. Visual inspection of the coating surface using scanning electron microscopy revealed that the coated carbons with the large losses in canister working capacity had coatings without any surface openings, such as microfissures, cracks or crevices. FIG. 1 shows the surfaces of the coated carbons with these openings and FIG. 2 shows the surfaces of coated carbons that lacked these openings. FIG. 3 is a graphical comparison of canister working capacities and the quantified area of surface openings. There was a sharp loss in canister performance when the concentration of microfissures (cracks, or crevices) dropped below about 1 mm of microfissure (crack, or crevice)-length per mm² of coated surface, equal to about 2 μm² microfissure(crack, or crevice)-open-area per mm² of coated surface.

For polyethylene, a polymer that tended to give the desired area of surface openings, a reduction in the concentration of microfissures, cracks, or crevices resulted in poorer canister working capacity performance. This suggests that the effect on performance may depend on the amount of surface opening area in the coating, and may not necessarily be dependent on the polymer selection, per se. A reduction in visible fissures was accomplished by twice coating a pellet sample with 1 wt % polyethylene per coating (Table III). Whereas a carbon coated to 2 wt % polyethylene in a single step had a highly fissured surface and only a 4% difference in working capacity versus uncoated carbon, the twice-coated carbon had about one-third fewer microfissures, cracks or crevices on its surface and a greater, 19% loss in canister working capacity compared with uncoated carbon.

### Experimental Details

Coating Method. Samples of clay-bound, wood-based activated carbon pellets, 2 mm BAX 1100, were coated with different aqueous polymer emulsions to polymer loadings of 2 wt % emulsion solids on the activated carbon. The activated carbon pellets were coated while tumbling in an inclined rotating cylinder at ambient temperature. An emulsion of the polymer was sprayed on the carbon in a single dose. The solids concentrations in the sprays were 8.8 wt % by diluting the as-received raw emulsions with appropriate aliquots of water. The coated activated carbons were then dried for 16 hours at 220° F. (105° C.). The final coated products had a shiny, smooth appearance, compared with the dull exterior of the uncoated material.

Density and BWC Measurements. The butane activity and butane working capacity (BWC) values were determined according to ASTM standard techniques described in U.S. Pat. No. 5,204,310.

Butane activity is the weight gain of a small bed (0.017 L) of activated carbon from equilibrium saturation with 100% n-butane vapors at 25° C. and 1 atmosphere, expressed as g-butane per 100 g-carbon or product.

The BWC measurement involved subjecting the small bed of activated carbon to a 25° C. clean air purge of about 700 bed volumes, applied subsequent to the equilibrium saturation of the sample with 100% butane vapors at 25° C. The BWC value is typically reported on a volume-bed basis (g/dL) and is a widely accepted surrogate measure of working capacity performance of activated carbons for evaporative emission control canisters.

The apparent densities, or “AD” values, were measured by a slow, 0.75-1.0 sec/cc fill of 150 mL of activated carbon particles into a 250 mL glass graduated cylinder.

Dust Measurements. Initial dust and dust rate values were measured by the “Standard Test Method for Dusting Attrition of Granular Carbon” (ASTM D5159-91). A 1.0 dL sample of carbon was placed on a screen with 0.250 mm openings (60 mesh U.S. Std) in a test cell holder and was then subjected to vibration of 40 m/s/s RMS acceleration and downward air flow of 7 L/min for a 10 minute interval. A glass fiber filter, placed below the sample screen, collected dust from the sample (Pall Corp., type A/E glass, 76 mm, p/n 61663). The vibration and airflow step was conducted six times with six fresh filters. The dust rate, DR, is expressed in units of mg/min/dL and was calculated as the slope of a plot of cumulative weight gain by filters #2 through #6 versus the cumulative time of vibration and air flow for those filters.

The initial dust was calculated as the milligram weight gain for the first filter minus the amount of dust calculated as attriting within its 10 minutes of vibration and air flow, i.e., 10×DR:
Initial Dust (mg/dL)=Wt of Filter #1-10 DR

2-Liter Canister Tests. The fast vapor loading canister tests were conducted with a 1.92 L canister that was partitioned in two volumes: A 1.42 L bed volume on the butane vapor inlet (81.1 cm2 cross-section, 17.5 cm flow path length) and a 0.50 L bed volume on the vent-side (28.6 cm2 cross-section, 17.5 cm flow path length). For determining canister working capacity performance, the canister was conditioned between repeated cycles of adsorption (50% n-butane in nitrogen, 48 g/min butane; end of adsorption: 5,000 ppm breakthrough) and purge (38.4 L/min nitrogen for 20 minutes, equal to 400 liters of total flow per liter of carbon bed). The adsorption and purge steps were akin to the cycling conditions of an evaporative emission control canister for onboard refueling vapor recovery except that a multi-hour static “soak” was not applied after each purge step. Steady state working capacities were typically obtained after 8 consecutives cycles of adsorption and purge. For those carbon samples with bleedthrough emissions that exceeded 5,000 ppm, each adsorption step was conducted until a rapid breakthrough of emissions was detected.

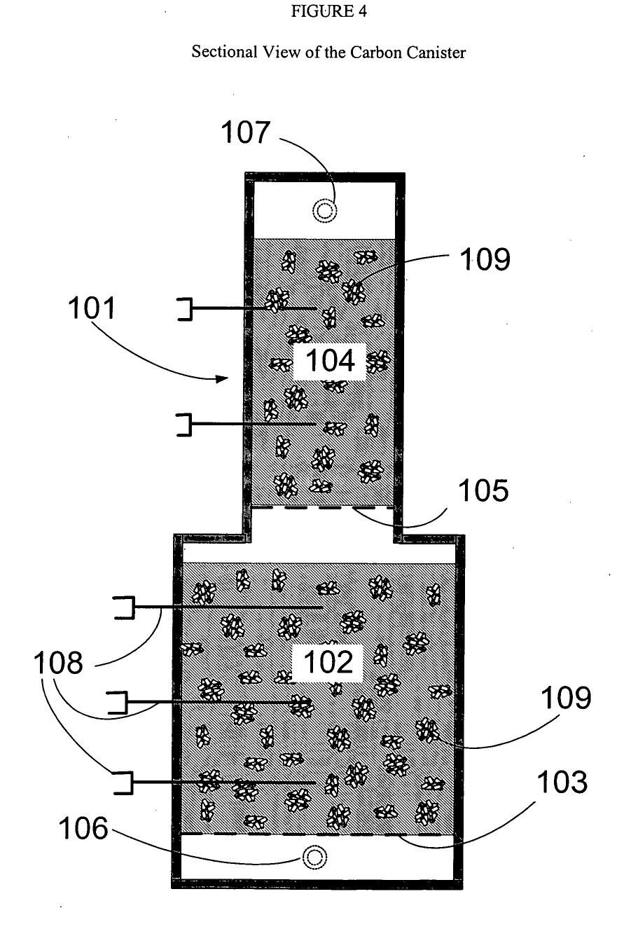

FIG. 4 is a sectional view of the test canister, shown as 101. Canister 101 was constructed out of PVC pipe, and had a carbon bed section 102 on the vapor inlet with support screen 103 and a carbon bed section 104 on the vent-side with support screen 105. A port 106 provided for the adsorption flow inlet /purge flow outlet, and a port 107 provided for the purge flow inlet /adsorption flow outlet. Thermocouples 108 for temperature measurement were located along the centerline of the flow path. For carbon addition or removal, section 102 was separated from section 104 by way of a threaded fitting between the two sections, and a threaded cap above section 104 was removed. Carbon pellets 109 were added to each section at a slow rate of addition (˜1 sec/cc) in order to assure maximum packed bed density.

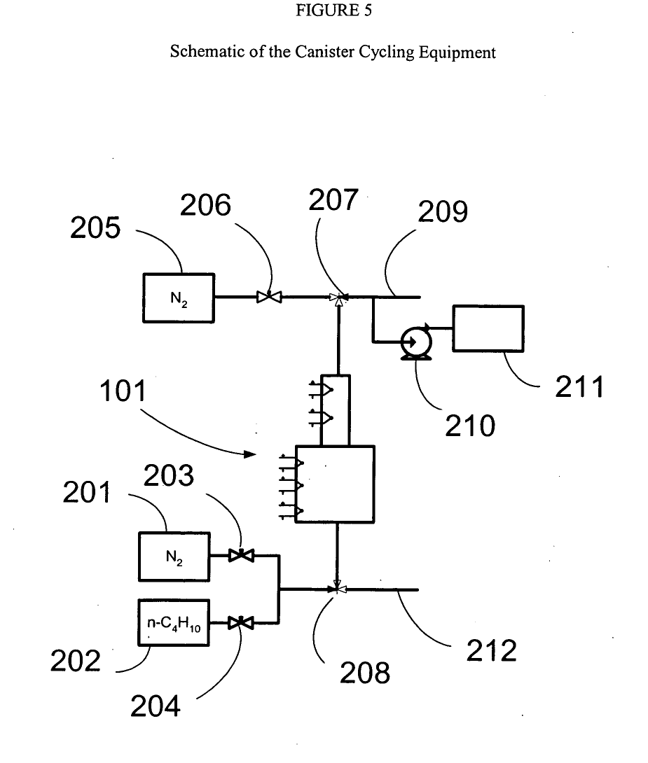

FIG. 5 is a schematic of the canister cycling equipment. The vapor for quantifying working capacity was instrument grade n-butane (n-C4H10). The vapor laden gas stream was generated by mixing gas flows from a nitrogen supply 201 and n-butane supply 202 via needle valves 203 and 204 and a joining tubing tee. The purge flow was generated by metering nitrogen gas 205 with a needle valve 206. A pair of three-way pneumatic ball valves 207 and 208, in appropriate positions, supplied either the butane-laden nitrogen up through the canister 101 for adsorption cycles or nitrogen flow down through the canister 101 for purge cycles. During adsorption cycles, a 21 L/min flow of nitrogen 201 was blended with 20 L/min flow (48 g/min) of n-butane 202, with the three-way valves 207 and 208 positioned to enable flow through the canister 101 and out the effluent line 209. A slip stream from the effluent line 209 was sampled by a diaphragm pump 210 and tested for n-butane concentration by a hydrocarbon analyzer 211 (Rosemont Analytical non-dispersive infrared analyzer, model 880A). When the effluent concentration of n-butane during adsorption exceeded 0.5 vol % (1% of the influent concentration), the three-way valves 207 and 208 were repositioned to cut off the n-butane laden nitrogen flow and to start the purge cycle with flow from nitrogen source 205 and out the vent 212. Purge was applied for 20 minutes with the flow rate adjusted by valve 206 in order to attain the desired total purge volume. Incoming gas and vapor flows and the ambient temperature were maintained at 21±1° C. The canister 101 was weighed after adsorption cycles and purge cycles, with the weight difference between consecutive adsorption and purge steps determining the working capacity for n-butane expressed as grams or grams/liter-adsorbent. Approximately eight repeated cycles of adsorption and purge were required for the working capacity to reach a steady state value, defined as a variability of less than ±0.0-0.6 g/L between successive cycles.

Coating Surface Morphology. Scanning electron micrographs were generated at 500× magnification. The total lengths of the surface openings were quantified by overlaying lines, each equivalent to 10 μm in length, onto the image, and then totaling the number of overlaid lines. The widths of the lines were 1.5 μm and were about the widths of the microfissures, crevices, or cracks. By multiplying the total lengths by the 1.5 μm widths, the areas of the openings were obtained.

One embodiment of the applicants' invention is a method for capturing vapor from a fluid stream by routing said stream through a container comprising an adsorbent material exhibiting initial, pre-coating butane activity and butane working capacity and dynamic working capacity values and having its surface coated with a porous continuous film of a polymer, said polymer film being operable for at least one of a) essentially eliminating attrition of the adsorbent material resulting from dusting or b) coloring the adsorbent material, and wherein the coated adsorbent material exhibits final, post-coating butane activity and butane working capacity values at least 90% of the initial, respective pre-coating values, and final post-coating dynamic working capacity values at least 80% of the initial pre-coating value. Adsorbent materials in pellet or particulate form may be coated by spraying an emulsion of the polymer onto exposed surfaces of the adsorbent material while it is in a state of turbulence at a processing temperature above ambient temperature; and drying the coated adsorbent material at above ambient temperature to cause surface openings, such as microfissures, to form in the coating. Adsorbent materials other than in pellet or particulate form (for example in sheet, monolith, or honeycomb forms) may also be coated by methods other than spraying, and need not be in a state of turbulence during coating application.

The polymer coating essentially eliminates attrition of the adsorbent material resulting from dusting.

The porous coated adsorbent material is also a subject of the applicant's invention.

While the preferred embodiments of the present invention have been described, it should be understood that various changes, adaptations, and modifications may be made thereto without departing from the spirit of the invention and the scope of the appended claims. It should be understood, therefore, that the invention is not to be limited to minor details of the illustrated invention shown in preferred embodiment and the figures and that variations in such minor details will be apparent to one skilled in the art. The claims, therefore, are to be accorded a range of equivalents commensurate in scope with the advances made over the art.

What is claimed is:

1. A coated adsorbent material having a polymer coating, said coating having a surface opening area of at least about 2 μm² open area at the external surface per mm² of coated surface.

2. The coated adsorbent material of claim 1, wherein said open area is in the form of microfissures, cracks, crevices, holes, or craters in said coating.

3. The coated adsorbent material of claim 1 wherein said adsorbent material is of a form selected from the group consisting of particulates, beads, granules, pellets, fibers, blocks, monoliths, honeycombs, fabrics, and sheets, and combinations thereof.

4. The coated adsorbent material of claim 1 wherein said polymer is selected from the group consisting of polyolefins, polyethylene, polypropylene, polyisobutylene, polystyrene, polyisoprene, polychloroprene, poly-4-methyl-1-pentene, polybutadiene, polybutene; polyacrylics, polyacrylates, polymethyl methacrylate, polybutylmethacrylate, polymethacrylates, polyacrylic acid, halogen-substituted alkanes, polytetrafluoroethylene, trifluoroethylene, vinyl fluoride, fluorvinylidene, fluorobutylene, and fluoropropylene, polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate butyrate, cellulose acetate phthalate, cellulose propionate morpholinobutyrate, hydroxypropylmethyl cellulose, ethylene vinyl acetate, acrylic copolymers, polysulfones, polyether sulfones, polyethers, polyalkylene glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, polymethacrylonitrile, polyacrylonitrile, polyvinylpyridine, polyvinyl acetate, polyvinylpyrrolidone, polyvinyl butyral, polyvinyl alcohol, polyvinyl chloride, polyvinyl formal, polyformaldehyde, polycarbonates, and polyvinylidene chloride.

5. The coated adsorbent material of claim 4 wherein said polymer is selected from the group consisting of polysiloxane, acrylic copolymer and polyethylene.

6. The coated adsorbent material of claim 1 wherein said adsorbent material is derived from a member of the group of carbon precursors consisting of coal, lignocellulosic materials, petroleum, resin, polymer, bone, and blood.

7. The coated adsorbent material of claim 6 wherein said lignocellulosic materials are selected from the group consisting of pulp, paper, residues from pulp production, wood chips, sawdust, wood flour, nut shell, kernel, and fruit pits.

8. The coated adsorbent material of claim 1 wherein said coating comprises an insoluble colorant selected from the group consisting of organic and inorganic compounds.

9. The coated adsorbent material of claim 8 wherein said insoluble colorant is selected from the group consisting of powders, dispersions, chromophores grafted to an insoluble solid additive, colorants immobilized in the polymer, and chromophores grafted to the polymer.

10. The coated adsorbent material of claim 9 wherein said insoluble colorant is an indicator compound.

11. The coated adsorbent material of claim 10 wherein said indicator compound is selected from the group consisting of compounds that gain color, change color, and lose color.

12. The coated adsorbent material of claim 1 where the form of said adsorbent material is selected from the group consisting of particulates, beads, pellets, fibers, blocks, monoliths, honeycombs, fabrics, and sheets, and combinations thereof.

13. The coated adsorbent material of claim 1 wherein said coating has been chosen that will form surface openings upon drying or heat treatment.

14. The coated adsorbent material of claim 1 wherein the elasticity of said coating was reduced in order to cause surface openings to form upon drying or heat treatment.

15. The coated adsorbent material of claim 1, wherein the glass transition temperature of said coating was increased in order to cause surface openings to form upon drying or heat treatment.

16. The coated adsorbent material of claim 1, wherein solubilizing, volatilizing, or sublimation additives were added to said coating to create surface openings upon washing, drying, or heat treatment.

17. The coated adsorbent material of claim 1, wherein solids were added to said coating which created surface openings at the coating-solid boundary.

18. A filter for removing contaminants, said filter comprising the coated adsorbent material of claim 1.

19. An emission control device comprising the coated adsorbent material of claim 1.

20. A method for creating an adsorbent material by coating adsorbent material with at least one film layer of polymer emulsion, wherein drying or heat treatment causes surface openings in the polymer coating of at least about 2 μm² open area at the external surface per mm2 of coated surface.

21. The method of claim 20, wherein said surface openings are in the form of microfissures, cracks, crevices, holes, or craters in said coating.

22. The method of claim 20 wherein said adsorbent material is prepared by the steps of: (a) spraying polymer emulsion onto exposed surfaces of said adsorbent material, and (b) drying the coated adsorbent material.

23. The method of claim 22 comprising a further step of: (c) de-dusting the dry, coated adsorbent material by removing any residual dust therefrom.

24. The method of claim 20 wherein said polymer is selected from the group consisting of polyolefins, polyethylene, polypropylene, polyisobutylene, polystyrene, polyisoprene, polychloroprene, poly-4-methyl-1-pentene, polybutadiene, polybutene; polyacrylics, polyacrylates, polymethyl methacrylate, polybutylmethacrylate, polymethacrylates, polyacrylic acid, halogen-substituted alkanes, polytetrafluoroethylene, trifluoroethylene, vinyl fluoride, fluorvinylidene, fluorobutylene, and fluoropropylene, polyurethane, polyethylene terephthalate, styrene butadiene, modified polybutadiene, epoxies, modified alkyds, polyesters, starches, methyl cellulose, ethyl cellulose, carboxymethyl cellulose, polyvinyl acetate, cellulose acetate, cellulose nitrate, cellulose triacetate, cellulose acetate butyrate, cellulose acetate phthalate, cellulose propionate morpholinobutyrate, hydroxypropylmethyl cellulose, ethylene vinyl acetate, acrylic copolymers, polysulfones, polyether sulfones, polyethers, polyalkylene glycols, polyimines, polybutylene, polyvinyl ethers, polyvinyl esters, polyalkylsulfides, polyarylsulfides, lignosulfonates, polyacrylamide, cyanoacrylate, polyamides, polyimides, polysiloxanes, polymethacrylonitrile, polyacrylonitrile, polyvinylpyridine, polyvinyl acetate, polyvinylpyrrolidone, polyvinyl butyral, polyvinyl alcohol, polyvinyl chloride, polyvinyl formal, polyformaldehyde, polycarbonates, and polyvinylidene chloride.

25. The method of claim 24 wherein said polymer is selected from the group consisting of polysiloxane, acrylic copolymer and polyethylene.

26. The method of claim 20 wherein said adsorbent material is an active carbon material derived from a member of the group consisting of coal, lignocellulosic materials, petroleum, resin, polymer, bone, and blood.

27. The method of claim 26 wherein said lignocellulosic materials are selected from the group consisting of including pulp, paper, residues from pulp production, wood chips, sawdust, wood flour, nut shell, kernel, and fruit pits.

28. The method of claim 20 wherein said coating comprises an insoluble colorant selected from the group consisting of organic and inorganic compounds.

29. The method of claim 28 wherein said insoluble colorant is selected from the group consisting of powders, dispersions, chromophores grafted to an insoluble solid additive, colorants immobilized in the polymer, and chromophores grafted to the polymer.

30. The method of claim 29 wherein said insoluble colorant is an indicator compound.

31. The method of claim 30 wherein said indicator compound is selected from the group consisting of indicator compounds that gain color, change color, and lose color.

32. The method of claim 20 where the form of said adsorbent material is selected from the group consisting of particulates, beads, pellets, fibers, blocks, monoliths, honeycombs, fabrics, and sheets, and combinations thereof.

33. The method of claim 20 wherein said coating is chosen that will form said surface openings upon drying or heat treatment.

34. The method of claim 20, wherein said surface openings are created by rapidly drying said adsorbent material after coating.

35. The method of claim 20 wherein the elasticity of said coating is reduced in order to cause said surface openings to form upon drying or heat treatment.

36. The method of claim 20, wherein the glass transition temperature of said coating is increased in order to cause said surface openings to form upon drying or heat treatment.

37. The method of claim 20, wherein solubilizing, volatilizing, or sublimation additives are added to said coating to create said surface openings upon washing, drying, or heat treatment.

38. The method of claim 20, wherein volatilizing or sublimation additives are added to said adsorbent material prior to coating, and after coating said additives are flashed out of out of said adsorbent material to create said surface openings in said coating.

39. The method of claim 20, wherein solids are added to said coating which create said surface openings at the coating-solid interface.

40. The method of claim 20, wherein said surface openings are created by physical means that disrupt the coating.

41. The method of claim 20, wherein said surface openings are created by laser ablation, tumbling, or vibration.

42. The method of claim 20, wherein said adsorbent material is in a particulate or pellet form and is coated according to the steps of:
(a) spraying an emulsion of the polymer onto exposed surfaces of said adsorbent material while it is in a state of turbulence at a processing temperature above ambient temperature; and
(b) drying the coated adsorbent material at above ambient temperature.

43. The method of claim 42 further comprising an initial step of heating said adsorbent material at above ambient temperature.

44. The method of claim 42 wherein the processing temperature is maintained from 50° F. (10° C.) to 280° F. (138° C.) for from about 1 minute to about 12 hours.

45. The method of claim 44 wherein the processing temperature is maintained from about 70° F. (21° C.) to about 250° C. (121° C.) for from about 5 minutes to about 6 hours.

46. A method for capturing vapor from a fluid stream containing same by routing said stream through an adsorbent material having its surface coated with a continuous film of a polymer, said polymer film having surface openings of at least about 2 μm² open area at the external surface per mm2 of coated surface.

47. A method for capturing gasoline vapor and combustion emission from a fluid stream containing same by routing said stream through a polymer-coated adsorbent material having surface openings of at least about 2 μm² open area at the external surface per mm² of coated surface.
